(19) United States
(12) Patent Application Publication
(10) Pub. No.: US 2014/0356544 A1
(43) Pub. Date: Dec. 4, 2014

(54) RESIN MOLDED BODY FOR ELECTROSTATIC COATING

(71) Applicant: SHOWA DENKO K.K., Minato-ku, Tokyo (JP)

(72) Inventors: Tatsuro Fukui, Tokyo (JP); Daisuke Miyamoto, Tokyo (JP)

(73) Assignee: SHOWA DENKO K.K., Minato-ku, Tokyo (JP)

(21) Appl. No.: 14/367,027

(22) PCT Filed: Dec. 20, 2012
(86) PCT No.: PCT/JP2012/083077

§ 371 Date: Jun. 19, 2014

(30) Foreign Application Priority Data
Dec. 20, 2011 (JP) 2011-278563

(51) Int. Cl. C08K 7/06; B05D 1/00; B05D 1/02

(52) U.S. Cl. CPC C08K 7/06; B05D 1/02; B05D 1/007; C08K 2201/001; C08K 2201/003; C08K 2201/011
USPC 427/458; 524/496

(57) ABSTRACT

The present invention relates to a resin molded body for electrostatic coating, which contains resin and carbon fiber that have an average fiber diameter of from 1 nm to 150 nm (inclusive), and which has a surface resistivity of from 1.0×10³Ω/□ to 9.9×10¹³Ω/□ (inclusive) and a volume resistivity of from 1.0×10³ Ω·cm to 9.9×10⁵ Ω·cm (inclusive). This resin molded body for electrostatic coating exhibits excellent coating efficiency by means of electrostatic coating, while having excellent mechanical properties.

### TECHNICAL FIELD

The present invention relates to a resin molded body for electrostatic coating.

### BACKGROUND ART

A molded body formed of a thermoplastic resin, which is produced mainly by injection molding, is widely used in the field of industrial components. It is known that such molded body is subjected to surface coating with a view to, for example, improving design and enhancing weather resistance, impact resistance, and scratch resistance of a base resin.

As a coating method for the molded body formed of a thermoplastic resin, the method involving improving coating efficiency, “electrostatic coating” is performed. “Electrostatic coating” involves applying electrical current to a conductive molded body formed of a thermoplastic resin and spraying the molded body with a coating material having the opposite charge. This method utilizes property of mutual attraction of a surface of the molded body and the coating material with opposite charges, to thereby achieve an improved adhesion rate of the coating material.

In general, electrostatic coating of an insulating molded body formed of a thermoplastic resin involves, prior to applying a top coat, applying a conductive primer onto the molded body to make its surface electrically-conductive with a view to improving coating efficiency, as disclosed in Patent Document 1.

It is also known that electrical conductivity or thermal conductivity is imparted to an insulating thermoplastic resin by blending a carbon-based filler such as carbon black, acetylene black, or Ketchen black, or a metal-based filler such as metal powder into the resin.

Patent Document 2 proposes, as a method of imparting surface conductivity, a method of imparting surface conductivity to a molded body formed of an insulating thermoplastic resin by blending a conductive filler into the resin and then molding the resin.

Patent Documents 3 to 6 disclose use of carbon nanotubes as a conductive filler.

### PRIOR ART DOCUMENT

### Patent Document

[Patent Document 1] JP 2006-045384 A
[Patent Document 2] WO 2004/050763 A
[Patent Document 3] WO 2000/68299 A
[Patent Document 4] JP 2004-143239 A
[Patent Document 5] JP 2009-280825 A
[Patent Document 6] JP 2010-043265 A

### SUMMARY OF INVENTION

### Problem to be Solved by the Invention

The method disclosed in Patent Document 2 requires the conductive filler to be added in a large amount for imparting surface conductivity necessary for improving the coating efficiency in the electrostatic coating. The use of the conductive filler in a large amount leads to the degradation in mechanical properties including strength, elongation and impact properties, and poor surface appearance of a resin molded body to be obtained.

As disclosed in Patent Documents 3 to 6, in the case of using carbon nanotubes, conductivity is exhibited with a low addition amount because of its high aspect ratio, as compared to the case of using the filler in a particulate form such as carbon black described above. In general, when a filler is added in a small amount, degradation in properties is less observed as compared to a matrix resin. However, in practical use, it is difficult to disperse carbon nanotubes uniformly in the matrix resin, which may result in problems of poor dispersion and molding defects. Thus, it has been difficult to satisfy intended design values.

### Solution to Problem

(1) A resin molded body for electrostatic coating, having a surface resistivity of 9.9×10¹³ ohms per square (Ω/□) or less and a volume resistivity of 9.9×10⁵ Ω·cm or less.

(2) The resin molded body for electrostatic coating according to (1) above, in which the resin molded body for electrostatic coating has a surface resistivity of 1.0×10³Ω/□ or more and 9.9×10¹³Ω/□ or less and a volume resistivity of 1.0×10³ Ω·cm or more and 9.9×10⁵ Ω·cm or less.

(3) The resin molded body for electrostatic coating according to (1) or (2) above, in which the resin molded body for electrostatic coating includes a mixture of a carbon material and a thermoplastic resin.

(4) The resin molded body for electrostatic coating according to (3) above, wherein the carbon material is composed of carbon fiber.

(5) The resin molded body for electrostatic coating according to (4) above, wherein the carbon fiber is composed of carbon nanotubes.

(6) The resin molded body for electrostatic coating according to any one of (3) to (5) above, in which the thermoplastic resin includes at least one member selected from an ABS resin, an AES resin, an ASA resin, an AS resin, an HIPS resin, a styrene-acrylonitrile copolymer, polyethylene, polypropylene, polycarbonate (PC), an alloy of polycarbonate and ABS (PC/ABS), polyphenylene ether (PPE), and polyamide (PA).

(7) The resin molded body for electrostatic coating according to any one of (3) to (6) above, wherein the content of the carbon material is 0.5 to 10 parts by mass with respect to 100 parts by mass of the thermoplastic resin.

(8) A method of electrostatically coating a resin molded body, the method including spraying an electrically-charged coating material onto a resin molded body for electrostatic coating having a surface resistivity of 9.9×10¹³Ω/□ or less and a volume resistivity of 9.9×10⁵ Ω·cm or less.

(9) A method of manufacturing a resin molded body having a coating film, the method including spraying an electrically-charged coating material onto a resin molded body for electrostatic coating having a surface resistivity of 9.9×10¹³Ω/□ or less and a volume resistivity of 9.9×10⁵ Ω·cm or less.

(10) A method of manufacturing a vehicle component having a coating film, the method including spraying an electrically-charged coating material onto a resin molded body for electrostatic coating having a surface resistivity of 9.9×10¹³Ω/□ or less and a volume resistivity of 9.9×10⁵ Ω·cm or less.

### Effects of Invention

According to a preferred embodiment of the present invention, it is possible to provide a resin molded body for electrostatic coating that exhibits excellent coating efficiency by means of electrostatic coating, while having excellent mechanical properties.

### BRIEF DESCRIPTION OF DRAWINGS

FIG. 1 is a correlation diagram of each resistivity and coating efficiency evaluated in Examples.

### MODE FOR CARRYING OUT THE INVENTION

### (1) Resin Molded Body for Electrostatic Coating

It is known that, in the molding of a resin, heterogeneity is observed between the surface and the central portion. For example, in the case of a molded body formed of a thermoplastic resin, a molded body is produced by melting the resin by heat, filling the melted resin into a cavity of a mold at a low temperature, and solidifying the resin by cooling. In this case, orientation occurs through formation of layers having different resin flows owing to a difference in cooling rate. Thus, a skin layer and a core layer are formed in a direction perpendicular to the flow.

The skin layer means a portion within about 200 μm and the core layer means a portion under the depth of about 200 μm or more from the surface of molded body to be obtained in the thickness direction.

In the molding of a resin having conductive carbon fibers added thereto, the filler is differently-oriented in the skin layer and the core layer, which provides different electrical conduction properties in the layers. Therefore, it is impossible to control the coating efficiency in the actual electrostatic coating process and the mechanical properties by controlling only the surface resistivity of a resin molded body. Further, it is impossible to control the coating efficiency in the actual electrostatic coating process and the mechanical properties by controlling only the volume resistivity of a resin molded body. For example, for reducing the surface resistivity of a resin molded body to a value enabling the electrostatic coating (for example, 10⁴ to 10⁵Ω/□), the addition of a large amount of conductive carbon fibers is required, resulting in degradation in mechanical properties of a resin molded body.

For a resin molded body obtained by kneading a resin and a conductive filler, each resistivity of the skin layer and the core layer is controlled within a predetermined range for achieving satisfactory coating properties in the electrostatic coating without using a conductive primer.

For a conductive resin obtained by kneading a resin and a conductive filler, it is necessary to limit each resistivity of the skin layer and the core layer to a certain level or less for achieving satisfactory coating properties in the electrostatic coating without using a conductive primer. In a preferred embodiment of the present invention, the surface resistivity of the resin molded body is controlled to 1.0×10³Ω/□ or more and 9.9×10¹³Ω/□ or less and the volume resistivity of the resin molded body is controlled to 1.0×10³ Ω·cm or more and 9.9×10⁵ Ω·cm or less. The lower limit of the surface resistivity is more preferably 1.0×10⁸Ω/□, still more preferably 1.0×10¹⁰Ω/□. The upper limit of the surface resistivity is more preferably 1.0×10¹²Ω/□. The upper limit of the volume resistivity is more preferably 1.0×10⁵ Ω·cm.

The control of the surface resistivity to less than 1.0×10³Ω/□ requires the incorporation of a conductive filler in a large amount, which leads to degradation in properties of a matrix resin as well as an economic disadvantage. When the surface resistivity exceeds 10¹⁴Ω/□, the coating efficiency tends to decrease.

The resin molded body for electrostatic coating having such resistivities exhibits excellent coating efficiency even if any one of the surface resistivity or the volume resistivity is higher than the conventional value.

That is, even a material having a high surface resistivity can exhibit satisfactory coating efficiency by controlling the volume resistivity within a predetermined range. As a result, the amount of the conductive filler to be added can be reduced, and thus, degradation in the mechanical properties of the molded body can be suppressed. It should be noted that, even if the volume resistivity falls within a predetermined range, when the surface resistivity is too high, the coating efficiency decreases.

In the present description, the surface resistivity and the volume resistivity can be measured by methods described in Examples.

### (2) Resin

A resin to be used in the present invention is not particularly limited, but it is preferred to use resins having high impact properties and high flowability.

Examples of the resin having high impact properties include thermoplastic resins each having an IZOD impact strength of 200 J/m or more. Examples of the resin having high flowability include thermoplastic resins each having a melt flow rate of from 10 to 30 g/10 min. (220° C., 10 kgf load)

Specific examples thereof include: styrene-based (co)polymers such as polystyrene, a styrene-acrylonitrile copolymer, a styrene-maleic anhydride copolymer, and a (meth)acrylate-styrene copolymer; rubber-reinforced resins such as an acrylonitrile-butadiene-styrene (ABS) resin, an acrylonitrile-ethylene (EPDM)-styrene (AES) resin, an acrylonitrile-styrene-acrylate (ASA) resin, and a high impact polystyrene (HIPS) resin; olefin-based resins such as an α-olefin (co)polymer) polymer whose monomer is at least one member of α-olefins having 2 to 10 carbon atoms such as polyethylene, polypropylene, and an ethylene-propylene copolymer and a modified polymer thereof (such as chlorinated polyethylene), and a cyclic olefin copolymer; ethylene-based copolymers such as an ionomer, an ethylene-vinyl acetate copolymer, and an ethylene-vinyl alcohol copolymer; vinyl chloride-based resins such as polyvinyl chloride, an ethylene-vinyl chloride polymer, and polyvinylidene chloride; an acrylic resin formed of a (co)polymer whose monomer is one or more kinds of (meth)acrylic acid esters such as polymethyl methacrylate (PMMA); polyamide-based resins (PA) such as polyamide 6, polyamide 66, and polyamide 612; polycarbonate (PC); polyester-based resins such as polyethylene terephthalate (PET), polybutylene phthalate (PBT), and polyethylene naphthalate; a polyacetal resin (POM); polyphenylene ether (PPE); a polyarylate resin; fluororesins such as polytetrafluoroethylene and polyvinylidene fluoride; a crystal liquid polymer such as crystal liquid polyester; imide resins such as polyimide, polyamide imide, and polyether imide; ketone-based resins such as polyether ketone; sulfone-based resins such as polysulfone and polyether sulfone; a urethane-based resin; polyvinyl acetate; polyethylene oxide; polyvinyl alcohol; polyvinyl ether; polyvinyl butyrate; a phenoxy resin; a photosensitive resin; and a biodegradable plastic.

Of those resins, preferred are an ABS resin, an AES resin, an ASA resin, an AS resin, an HIPS resin, a styrene-acrylonitrile copolymer, polyethylene, polypropylene, polycarbonate (PC), an alloy of polycarbonate and ABS (PC/ABS), polyphenylene ether (PPE), and polyamide (PA). One kind of those resins may be used alone or two or more kinds thereof may be used in combination.

Further, the resin may be a resin obtained by adding any other elastomer or a rubber component to the above-mentioned thermoplastic resin for improving impact resistance. In general, as the elastomer to be used for improving impact resistance, the following are used: an olefin-based elastomer such as EPR or EPDM, a styrene-based elastomer such as SBR formed of a copolymer of styrene and butadiene, a silicon-based elastomer, a nitrile-based elastomer, a butadiene-based elastomer, a urethane-based elastomer, a polyamide-based elastomer, an ester-based elastomer, a fluorine-based elastomer, and natural rubber and a modified product obtained by introducing a reactive site (such as a double bond or a carboxylic anhydride group) into such elastomer.

### (3) Carbon Fiber

A carbon material to be added to the resin is not particularly limited, and for example, carbon fibers may be used. Examples of the carbon fibers that may be used include pitch-based carbon fibers, PAN-based carbon fibers, other carbon fibers, carbon nanofibers, and carbon nanotubes. From the viewpoint of reducing the addition amount of the carbon material, carbon nanotubes are preferably used. The carbon nanotubes according to a preferred aspect have a tubular form with a hollow in the central portion of the fiber, in which a graphene surface extends substantially parallel to the fiber axis. It should be noted that, in the present invention, the phrase “substantially parallel” means that the tilt of a graphene layer to the fiber axis is within about ±15 degrees. The hollow may be continuous or non-continuous in the longitudinal direction of the fiber.

As the fiber diameter of the carbon fibers to be added to the resin becomes smaller, a higher effect of imparting conductivity may be exhibited. The average fiber diameter is preferably 1 nm or more and 150 nm or less, more preferably 1 nm or more and 50 nm or less, particularly preferably 1 nm or more and 20 nm or less. From the viewpoint of dispersibility, the average fiber diameter is preferably 2 nm or more, more preferably 4 nm or more. As a result, in consideration of dispersibility and an effect of imparting conductivity, the average fiber diameter is preferably from 2 to 20 nm, most preferably from 4 to 20 nm.

The ratio of the inner diameter of the hollow d₀ to the fiber diameter d, (d₀/d), is not particularly limited, but is preferably from 0.1 to 0.9, more preferably from 0.3 to 0.9.

The lower limit of the BET specific surface area of the carbon fibers is preferably 20 m²/g, more preferably 30 m²/g, still more preferably 40 m²/g, particularly preferably 50 m²/g. The upper limit of the specific surface area is not particularly limited, but is preferably 400 m²/g, more preferably 350 m²/g, still more preferably 300 m²/g, particularly preferably 280 m²/g, most preferably 260 m²/g.

For evaluation of the surface crystal structure of the carbon fibers, various methods are proposed. An example of such methods is a method utilizing raman spectroscopy. Specifically, there is known an evaluation method based on the intensity ratio of the intensity of a peak in the range of from 1,300 to 1,400 cm⁻¹ (I_{D}) to the intensity of a peak in the range of from 1,580 to 1,620 cm⁻¹(I_{G}) measured in the raman spectroscopy, I_{D}/I_{G} (R value).

The R value of the carbon fibers is preferably 0.1 or more, more preferably from 0.2 to 2.0, still more preferably from 0.5 to 1.5. It should be noted that a larger R value indicates lower crystallinity.

The compressed specific resistance of the carbon fibers at a density of 1.0 g/cm³ is preferably 1.0×10⁻² Ω·cm or less, more preferably from 1.0×10⁻³ Ω·cm to 9.9×10⁻³ Ω·cm.

The fiber length of the carbon fibers is not particularly limited, but fibers being too small in length tend to decrease the effect of imparting conductivity and fibers being too long in length tend to give difficulty in dispersion in the matrix resin. Therefore, the length of the fibers is generally from 0.5 μm to 100 μm, preferably from 0.5 μm to 10 μm, more preferably from 0.5 μm to 5 μm, although the length depends on the diameter of the fibers.

The carbon fibers themselves may be linear or curved and undulated. However, undulating carbon fibers are more preferred, because such fibers adhere well to the resin and exhibit higher interfacial strength as compared to that of linear fibers, and thus degradation in the mechanical properties is suppressed when the fibers are added to a resin composite material. Another reason why undulating fibers are more preferred is as follows. Partly owing to such undulating structure, a network of the fibers becomes continuous even when the fibers are dispersed in the resin in a small amount. As a result, the fibers exhibit conductivity even in such a small-addition-amount region that substantially linear fibers as used in the conventional art do not exhibit conductivity.

The amount of the carbon fibers to be used in the resin molded body is preferably from 0.5 to 10 parts by mass with respect to 100 parts by mass of the resin. By using the preferred carbon fibers described above, the addition amount can be reduced. The addition amount of the carbon fibers is more preferably from 0.5 to 5 parts by mass. When the addition amount is less than 0.5 part by mass, it is difficult to form electrically-conductive or thermally-conductive paths sufficiently in the resin molded body. On the other hand, when the addition amount exceeds 10 parts by mass, i.e., the concentration is high, the properties of the resin itself are liable to be impaired.

### (4) Kneading Method

The mixing/kneading of components of the resin molded body for electrostatic coating having carbon fibers dispersed therein is preferably conducted with preventing the carbon fibers from breaking as much as possible. Specifically, the breaking ratio of the carbon fibers is preferably 20% or less, more preferably 15% or less, particularly preferably 10% or less. The breaking ratio is obtained by comparing the aspect ratios of the carbon fibers (for example, measured by scanning electron microscopy (SEM)) before and after the mixing/kneading. For mixing/kneading the carbon fibers with preventing the fibers from breaking as much as possible, for example, the following method may be used.

In general, in melt-kneading of a thermoplastic resin or a thermosetting resin and an inorganic filler, the filler is dispersed uniformly in the melted resin by applying a high shear force to the filler in an agglomerated state to finely pulverize the filler. When the shear force during the kneading operation is weak, the filler is not dispersed in the melted resin sufficiently and a resin composite material exhibiting expected performance or functions cannot be obtained. As a kneader that generates a high shear force, there are many kneaders utilizing grindstone mechanism or many co-rotating twin screw extruders employing a kneading disk in a screw element for applying a high shear force. However, in the case of kneading carbon fibers into a resin, when the shear force applied to the resin and the carbon fibers is too high, the carbon fibers are broken excessively, and thus, a resin composite material exhibiting expected performance or functions cannot be obtained. On the other hand, in the case of using single screw extruders of a lower shear force, the breaking of the carbon fibers is suppressed, but the carbon fibers are not dispersed uniformly.

Therefore, for achieving uniform dispersion with suppressing the breaking of the carbon fibers, it is desired to conduct kneading over a long period of time using a co-rotating twin screw extruder without a kneading disk, in which the shear force is reduced, or using a press kneader, in which a high shear force is not applied; or to conduct kneading using a single screw extruder with a special mixing element.

The kneading disk can be used in consideration of dispersibility of the carbon fibers when employing the co-rotating twin screw extruder. The kneading disk can be used.

The conditions of the melt-kneading such as a temperature, a discharge amount, and a kneading time can be appropriately determined depending on the type and capacity of a kneader, the properties of components of the resin molded body for electrostatic coating, the mixing ratio of the components, or the like.

### (5) Molding Method

Production of a molded body by using the compositions described above can be conducted by a conventionally-known molding method using a resin composition. Examples of the molding method include injection molding, blow molding, extrusion molding, sheet molding, thermoforming, rotational molding, laminate molding, and transfer molding. Of those, injection molding is preferred.

The molding temperature is set to a higher temperature than a temperature generally employed in injection molding of a thermoplastic resin. Specifically, the injection molding is conducted at a temperature higher than the injection molding temperature recommended for the resin used by from 10 to 60° C. For example, in the case of an ABS resin used in Examples of the present invention, the injection molding is conducted at preferably from 230° C. to 290° C., more preferably from 240° C. to 270° C. in a preferred embodiment of the present invention, while the recommended molding temperature of the resin suggested by its supplier is from 220 to 230° C. When the injection molding temperature is low, a shear force is liable to occur in the melted resin, particularly excessively in the skin layer, at the time of injection, and the carbon fibers are oriented along the flow direction of the resin, resulting in a higher resistivity. By setting the injection molding temperature to a higher temperature, less shear force occurs in the melted resin at the time of injection, the carbon fibers are randomly dispersed, and conductive paths among the carbon fibers are easily formed, resulting in a lower resistivity.

In addition, the injection speed is preferably small, and a minimum speed that does not impair the surface appearance or dimensional precision of the molded body is employed. When the injection speed is high, an excessive shear force is liable to occur in the melted resin, particularly in the skin layer, and the carbon fibers are oriented along the flow direction of the resin, resulting in a higher resistivity. By setting the injection speed to a lower value, less shear force occurs in the melted resin at the time of injection and then the carbon fibers are randomly dispersed, and conductive paths among the carbon fibers are easily formed, resulting in a lower resistivity.

By controlling the temperature and the injection speed, conductive paths are formed between the skin layer and the core layer by means of the network of the conductive filler. Hence, the obtained molded body exhibits excellent coating efficiency as compared to that of a molded body having the same resistivity.

### (6) Application

The resin molded body for electrostatic coating described above can be suitably used for coating of products or components requiring impact resistance and coating, for example, components to be used for office automation equipment or electronic devices, or vehicle components such as car components.

### EXAMPLES

Hereinafter, the present invention is specifically described with reference to Examples and Comparative Examples. Examples shown below are merely given for illustrative purposes and by no means limit the present invention.

Components used in examples and evaluation methods of physical properties are as follows.

[Component Used]

Components used in the Examples and Comparative Examples are as follows.

Thermoplastic resin: ABS resin (Toyolac 100-MPM manufactured by Toray Industries, Inc., melt flow rate (220° C., 10 kgf load): 15 g/10 min).

Carbon nanotube: VGCF (trademark)-X manufactured by Showa Denko K.K., average fiber diameter: 15 nm, average fiber length: 3 μm, BET specific surface area: 260 m²/g.

[Measurement Method for Surface Resistivity]

A sample of 100 mm×100 mm (the thickness was the same as that of a molded body) was cut out of a molded body, and the surface resistivity was measured by a double ring electrode method in accordance with JIS K6911. A voltage of 100 V was applied to the electrodes, and the resistivity was measured after 1 minute.

[Measurement Method for Volume Resistivity]

A sample of 60 mm×10 mm (the thickness was the same as that of a molded body) was cut out of a molded body and cross sections in the longitudinal direction were covered with conductive tapes, and the electrical resistance between the cut surfaces was measured. The resistance was measured by a digital insulation resistance tester (MY40 manufactured by Yokogawa Meters & Instruments Corporation) with applying a voltage of 500 V. The volume resistivity was calculated by the following equation.

Volume resistivity [Ω·cm]=resistance [Ω]×cross section area [cm²]/length of sample [cm]

[Melt Flow Rate (MFR)]

The melt flow rate was measured under the conditions of a test temperature of 220° C. and a test load of 10 kgf in accordance with ISO 1133.

[Izod Impact Strength]

An izod test specimen (with a notch) was produced and evaluated in accordance with ASTM D256.

[BET Specific Surface Area]

The BET specific surface area was measured by a BET method based on nitrogen gas adsorption at a liquid nitrogen temperature (77 K) by NOVA 1000 manufactured by Yuasa Ionics Inc.

[Coating Efficiency in Electrostatic Coating]

Electrostatic coating was conducted for a plate test sample flatly placed with applying voltage to the plate test sample by using a compact robot having an air atomizing electrostatic automatic coating gun upon supply of a coating material from a gear pump. The coating operation began with primer coating (color), followed by drying and then mass measurement. The coating operation continued to top coat coating (clear), followed by drying and then mass measurement again. The drying was performed by retaining the test sample at 80° C. for 20 minutes. The thickness of the coating film was set to 20 μm in the case of the primer and 30 μm in the case of the top coat. The amounts of the adhered coating materials were each obtained as the difference between the mass of the plate test sample preliminarily measured and the mass of the plate test sample after the drying. The coating efficiency was calculated based on the mass of the adhered coating material. The coating efficiency ratio was calculated as a ratio to the coating efficiency of Comparative Example 4 (case of using a conductive primer) defined as 1.

### Reference Example 1

100 parts by mass of an ABS resin and 1 part by mass of carbon nanotubes were provided from a main feed port of a co-rotating twin screw extruder (TEX 30α manufactured by The Japan Steel Works, LTD.), and a resin composition after kneading was cut and formed into a pellet with a pelletizer.

The obtained pellet was processed into a plate test sample (400 mm×200 mm×3 mm in thickness) with an injection molding machine (S-2000i 100B manufactured by FUNAC CORPORATION, cylinder diameter: 27 mm). For the test sample, the surface resistivity and the volume resistivity were measured.

After coating, the coating efficiency was calculated. The evaluation results are shown in Table 1.

### Reference Example 2 and Example 1

The same procedure as in Reference Example 1 was followed except that the amount of the carbon nanotubes was changed to 1.5 parts by mass and 2.0 parts by mass, respectively. The evaluation results are shown in Table 1.

Comparative Example 1 employed the same procedure as in Reference Example 1 except that a natural ABS resin (without a filler) was coated without applying a voltage to an electrostatic automatic gun. The evaluation results are shown in Table 1.

Comparative Example 2 employed the same procedure as in Reference Example 1 except that a conductive primer was applied onto a natural ABS resin. The evaluation results are shown in Table 1.

TABLE 1

| | Reference | Reference | | Comparative | Comparative |
|---|---|---|---|---|---|
| | Example 1 | Example 2 | Example 1 | Example 1 | Example 2 |
| Resin (part(s) by mass) | 100 | 100 | 100 | 100 | 100 |
| Carbon fiber (part(s) by | 1.0 | 1.5 | 2.0 | 0 | 0 |
| mass) | | | | | |
| Surface resistivity | 14 to 15 | 14 to 15 | 12 to 13 | | |
| (logΩ/cm²) | | | | | |
| Volume resistivity | 6 | 5 | 3 | — | — |
| (logΩ · cm) | | | | | |
| Izod impact strength (J/m) | 84 | 73 | 64 | 209 | 209 |
| MFR (g/10 min) | 9 | 8 | 6 | 15 | 15 |
| Conductive primer layer | Absent | Absent | Absent | Absent | Present |
| Coating efficiency of | 52 | 57 | 62 | 36 | 60 |
| color layer (%) | | | | | |
| Coating efficiency of | 57 | 61 | 66 | 46 | 63 |
| clear layer (%) | | | | | |

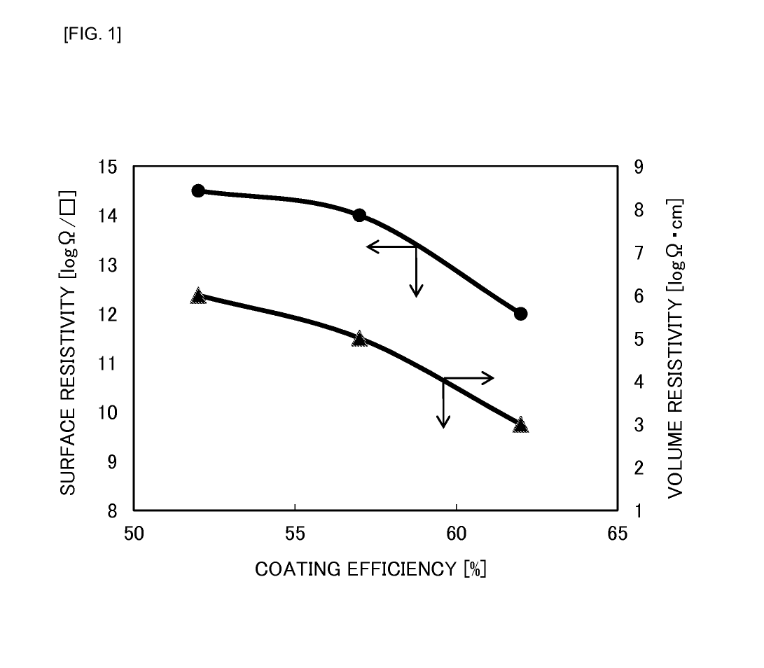

FIG. 1 shows the resistivities and coating efficiency for the results of Examples and Comparative Examples described above. FIG. 1 reveals that excellent coating efficiency can be achieved by controlling the surface resistivity (corresponding to the resistivity of the skin layer) and the volume resistivity (corresponding to the resistivity of the core layer) within predetermined ranges.

### Examples 2 and 3

100 parts by mass of an ABS resin and 2.0 parts by mass (Example 2) or 1.5 parts by mass (Example 3) of carbon nanotubes were provided from a main feed port of a co-rotating twin screw extruder (KZW15 TW manufactured by TECHNOVEL CORPORATION). Melt-kneading was performed under the following conditions: temperatures of six barrels in the extruder (the temperatures of heating zones) were set to 220° C., 230° C., 240° C., 250° C., 250° C., and 250° C., respectively, toward the extrusion direction; a temperature of a nozzle head was set to 250° C.; a screw rotation speed was set to 600 rpm; and a discharge amount was set to 2 kg/h. The composition after kneading was cut and formed into a pellet with a pelletizer. The screw element of the co-rotating twin screw extruder included three kneading disks so that the carbon nanotubes were uniformly dispersed in the melted resin.

The obtained pellet was processed into a plate test sample (350 mm×100 mm×2 mm in thickness) with an injection molding machine (FNX140 manufactured by NISSEI PLASTIC INDUSTRIAL CO., LTD., cylinder diameter: 40 mm). The test sample was subjected to measurement of physical properties. The molding conditions were a mold temperature of 60° C., a cylinder temperature of 260° C., and an injection speed of 5 mm/s. The cylinder temperature was set higher than the recommended temperature of the ABS resin, from 220 to 230° C.

Physical properties were measured and the coating efficiency was evaluated. The results are shown in Table 2.

### Example 4

The same procedure as in Example 2 was followed except that the injection speed was changed to 10 mm/s. The evaluation results are shown in Table 2.

### Comparative Examples 3 and 4

Plate test samples of 400 mm×200 mm×3 mm in thickness were obtained by the same procedure as in Example 2 except that the addition amount of the carbon nanotubes was changed to 1.5 parts by mass (Comparative Example 3) and 1.0 part by mass (Comparative Example 4) and an injection molding machine (S-2000i 100B manufactured by FUNAC CORPORATION, cylinder diameter: 27 mm) was used under the conditions of a mold temperature of 60° C., a cylinder temperature of 260° C., and an injection speed of 10 mm/s. The other operations were carried out in the same way as in Example 2. The evaluation results are shown in Table 2.

### Comparative Example 5

A plate test sample of 400 mm×200 mm×3 mm in thickness was obtained by molding an ABS resin with an injection molding machine (S-2000i 100B manufactured by FUNAC CORPORATION, cylinder diameter: 27 mm). The same procedure as in Example 2 was followed except that coating of the test sample was carried out without applying a voltage to the electrostatic automatic gun. The evaluation results are shown in Table 2.

### Comparative Example 6

A plate test sample of 400 mm×200 mm×3 mm in thickness was obtained by molding an ABS resin with an injection molding machine (S-2000i 100B manufactured by FUNAC CORPORATION, cylinder diameter: 27 mm). A conductive primer (primack No. 1700 conductive primer, manufactured by BASF Japan Ltd. Coatings) containing 1 to 5 parts by mass of carbon black was applied onto the test sample, followed by drying, to prepare a test sample. The test sample was evaluated as in Example 2. The results are shown in Table 2.

TABLE 2

| | Example | Example | Example | Comparative | Comparative | Comparative | Comparative |
|---|---|---|---|---|---|---|---|
| | 2 | 3 | 4 | Example 3 | Example 4 | Example 5 | Example 6 |
| Resin (part(s) by mass) | 100 | 100 | 100 | 100 | 100 | 100 | 100 |
| Carbon fiber (part(s) by mass) | 2.0 | 1.5 | 1.5 | 1.5 | 1.0 | 0 | 0 |
| Surface resistivity (logΩ/cm²) | 8 to 9 | 12 to 13 | 13 to 14 | 14 to 15 | 14 to 15 | — | 4 to 5 |
| Volume resistivity (logΩ · cm) | 4 | 5 | 5 | 5 | 6 | | |
| Izod impact strength (J/m) | 64 | 73 | 73 | 73 | 84 | 209 | 209 |
| MFR (g/10 min) | 6 | 8 | 8 | 8 | 9 | 15 | 15 |
| Conductive primer layer | Absent | Absent | Absent | Absent | Absent | Absent | Present |
| Coating efficiency of color | 1.17 | 1.14 | 1.02 | 0.94 | 0.84 | 0.60 | 1.00 |
| layer (to Comparative Example 4) | | | | | | | |
| Coating efficiency of clear | 1.04 | — | — | 0.95 | 0.89 | 0.73 | 1.00 |
| layer (to Comparative Example 4) | | | | | | | |

In each of Examples 2 to 4, the coating efficiency is 1 or more and such a characteristic that the coating efficiency is equal to or higher than that in the case of using a conductive primer can be obtained.

1. A resin molded body for electrostatic coating; containing carbon fibers having an average fiber diameter of 1 nm or more and 150 nm or less and a resin, and having a surface resistivity of 1.0×10³ ohms per square (Ω/□) or more and 9.9×10¹³Ω/□ or less and a volume resistivity of 1.0×10³Ω·cm or more and 9.9×10⁵Ω·cm or less.

2. The resin molded body for electrostatic coating according to claim 1, wherein the surface resistivity is 1.0×10³Ω/□ or more and 9.9×10¹²Ω/□ or less and the volume resistivity is 1.0×10³ Ω·cm or more and 1.0×10⁵Ω·cm or less.

3. The resin molded body for electrostatic coating according to claim 1, in which the resin includes at least one kind of thermoplastic resins selected from an ABS resin, an AES resin, an ASA resin, an AS resin, an HIPS resin, polyethylene, polypropylene, polycarbonate (PC), an alloy of polycarbonate and ABS (PC/ABS), polyphenylene ether (PPE), and polyamide (PA).

4. The resin molded body for electrostatic coating according to claim 1, wherein the content of the carbon fibers is 0.5 to 10 parts by mass with respect to 100 parts by mass of the resin.

5. A method of electrostatically coating a resin molded body, the method including spraying an electrically-charged coating material onto a resin molded body for electrostatic coating according to claim 1.

6. A method of manufacturing a resin molded body having a coating film, the method including spraying an electrically-charged coating material onto a resin molded body for electrostatic coating according to claim 1.

7. A method of manufacturing a vehicle component having a coating film, the method including spraying an electrically-charged coating material onto a resin molded body for electrostatic coating according to claim 1.
